(19) United States
(12) Patent Application Publication
(10) Pub. No.: US 2014/0053935 A1
(43) Pub. Date: Feb. 27, 2014

(54) Conduit Apparatus, System, and Methods Thereof

(71) Applicant: Dekoron Unitherm, Inc., Cape Coral, FL (US)

(72) Inventors: Jerry Bunch, JR., Fort Myers, FL (US); James Stahl, Cape Coral, FL (US); James Bradley, Pt. Charlotte, FL (US)

(73) Assignee: Dekoron Unitherm, Inc., Cape Coral, FL (US)

(21) Appl. No.: 13/973,364

(22) Filed: Aug. 22, 2013

Related U.S. Application Data
(60) Provisional application No. 61/693,010, filed on Aug. 24, 2012.

(51) Int. Cl. F16L 53/00; F16L 57/00

(52) U.S. Cl. CPC F16L 53/004; F16L 57/00
USPC 138/33; 138/103; 29/428

(57) ABSTRACT

A conduit apparatus, system, and method of using a conduit are disclosed. The conduit apparatus includes a plurality of fluid-transporting tubes. A cable channel is positioned substantially parallel to the plurality of fluid-transporting tubes. An elongated, temperature-controlling device is positionable within the cable channel. A bundling jacket is surrounding the plurality of fluid-transporting tubes and the cable channel.

### CROSS REFERENCE TO RELATED APPLICATION

This application claims benefit of U.S. Provisional Application Ser. No. 61/693,010 entitled ‘Conduit Apparatus and Methods Thereof’ filed Aug. 24, 2012, the entire disclosure of which is incorporated herein by reference.

### FIELD OF THE DISCLOSURE

The present disclosure is generally related to conduits and more particularly is related to a conduit apparatus, system, and method thereof.

### BACKGROUND OF THE DISCLOSURE

Conduits are used within many industries and for many different purposes. For example, in some industries conduits are used for fluid or gas transport, and it is often necessary to retain the fluid or gas within the conduit at a specific temperature. In colder climates, devices are used to keep fluid-transporting conduits above the freezing point of the fluid transported therein. One conventional way to heat the conduit is to place one or more heat cables within the conduit structure and proximate to the pipes or tubes that transport the fluid. These conventional heat cables are connected to a power source and generate heat which is conducted to the fluid transporting tubes within the conduit.

The use of conventional heat cables provides many benefits but also has some shortcomings. For example, between each conduit with a conventional heat cable, a connector must be utilized to connect the heat cable of one conduit with the heat cable of another conduit. When conduits are sold in lengths of twenty feet, many connectors may be needed for certain industries requiring extended lengths of conduits. Furthermore, the use of a connector between the conduit lengths leaves the conduits susceptible to damage from the environment, such as from water exposure, and prone to malfunction, since the conduit joint having the connector is often not as strong or durable as the conduit itself. Another limitation of conventional heating cables is that they are substantially permanent within the conduit. If the heating cable breaks or requires removal or replacement, it is highly difficult to remove it from the conduit without damaging the conduit, and it is virtually impossible to replace a damaged heating cable from a conduit with a new heating cable.

Thus, a heretofore unaddressed need exists in the industry to address the aforementioned deficiencies and inadequacies.

### SUMMARY OF THE DISCLOSURE

Embodiments of the present disclosure provide a conduit apparatus. Briefly described, in architecture, one embodiment of the system, among others, can be implemented as follows. The conduit apparatus includes a plurality of fluid-transporting tubes. A cable channel is positioned substantially parallel to the plurality of fluid-transporting tubes. An elongated, temperature-controlling device is positionable within the cable channel. A bundling jacket is surrounding the plurality of fluid-transporting tubes and the cable channel.

The present disclosure can also be viewed as providing a conduit system. Briefly described, in architecture, one embodiment of the system, among others, can be implemented as follows. A first conduit section has a first plurality of fluid-transporting tubes and a first cable channel positioned substantially parallel to the first plurality of fluid-transporting tubes. A second conduit section has a second plurality of fluid-transporting tubes and a second cable channel positioned substantially parallel to the second plurality of fluid-transporting tubes. A bundling jacket is positioned surrounding the first and second plurality of fluid-transporting tubes and the first and second cable channel. A connection device fluidly interfaces the first plurality of fluid-transporting tubes and the second plurality of fluid-transporting tubes and interfacing the first cable channel and the second cable channel. An elongated, temperature-controlling device is positioned within the first and second cable channels.

The present disclosure can also be viewed as providing method of using conduit. In this regard, one embodiment of such a method, among others, can be broadly summarized by the following steps: providing a first conduit section and a second conduit section, each of the first and second conduit sections having a plurality of fluid-transporting tubes, a cable channel positioned substantially parallel to the plurality of fluid-transporting tubes, and a bundling jacket positioned surrounding the plurality of fluid-transporting tubes and the cable channel; connecting the first conduit section to the second conduit section, wherein the plurality of fluid-transporting tubes and the cable channel within the first conduit section are aligned with the plurality of fluid-transporting tubes and the cable channel within the second conduit section, respectively; and feeding at least one continuous elongated, temperature-controlling device through each of the cable channels of the first and second conduit sections.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims.

### BRIEF DESCRIPTION OF THE DRAWINGS

Many aspects of the disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 is a front cross-sectional illustration of a conduit apparatus, in accordance with the first exemplary embodiment of the present disclosure.

FIG. 2 is side cross-sectional illustration of the conduit apparatus, in accordance with the first exemplary embodiment of the present disclosure.

FIG. 3 is a front cross-sectional illustration of a conduit apparatus, in accordance with a second exemplary embodiment of the present disclosure.

FIG. 4 is a flowchart illustrating a method of using conduit, in accordance with a third exemplary embodiment of the present disclosure.

### DETAILED DESCRIPTION

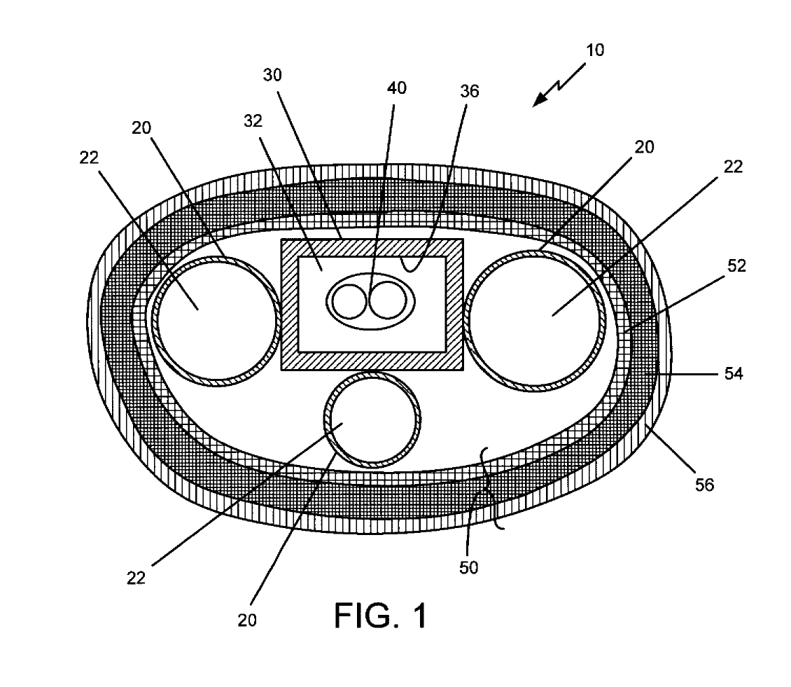

FIG. 1 is a front cross-sectional illustration of a conduit apparatus 10, in accordance with the first exemplary embodiment of the present disclosure. The conduit apparatus 10, which may be referred to herein as ‘apparatus 10’ includes a plurality of fluid-transporting tubes 20. A cable channel 30 is positioned substantially parallel to the plurality of fluid-transporting tubes 20. An elongated, temperature-controlling device 40 is positionable within the cable channel 30. A bundling jacket 50 is surrounding the plurality of fluid-transporting tubes 20 and the cable channel 30. The bundling jacket 50 may be comprised of an aluminum shield 52, a thermal insulation 54 positioned abutting the aluminum shield 52, and a jacket 56 positioned abutting the aluminum shield 54.

The conduit apparatus 10 may be used within a variety of industries and settings, including any setting having the need for a conduit, a temperature-controlled conduit, or a conduit with a cable positioned therein. The apparatus 10 may be formed with a variety of industry-specific materials, such as materials used to enhance the usability, durability, or maintenance of the apparatus 10. The apparatus 10 may also be formed at any size length, diameter, or width, as may be determined on the intended use of the apparatus 10. For example, the apparatus 10 may be formed with the fluid-transporting tubes 20 and the cable channel 30 having lengths of 20 feet (or any other length), with the elongated, temperature-controlling device 40 being longer than 20 feet.

The apparatus 10 includes a plurality of fluid-transporting tubes 20, having an interior portion 22 that is sized to hold, carry, and transport any type of fluid or gas. For example, the plurality of fluid-transporting tubes 20 may include any type of fluid-transporting pipe, conduit, hose, or similar structure. Any number of fluid-transporting tubes 20 may be included with the apparatus 10, and they may be constructed at any size and out of any type of material. The fluid-transporting tubes 20 may be pressurizable with a positive or negative pressure, such that they can withstand the pressures of pumping fluids. Additionally, the fluid-transporting tubes 20 may be capable of withstanding external pressures applied to the apparatus 10 from an exterior position, such as from the pressures of deep-water drilling operations.

Positioned proximate to and substantially parallel with the fluid-transporting tubes 20 is at least one cable channel 30. The cable channel 30 is positioned along the length of the apparatus 10 such that it is proximate to the fluid-transporting tubes 20 throughout the entire length of the fluid-transporting tubes 20. As is shown in FIG. 1, the cable channel 30 includes an interior portion 32 that is substantially hollow, thereby allowing the elongated, temperature-controlling device 40 to be positioned within the cable channel 30. While the elongated, temperature-controlling device 40 contacts an interior surface 36 of the cable channel 30, the elongated, temperature-controlling device may not be affixed, secured, or otherwise attached to the interior surface 36. It is noted that the cable channel 30 may be formed with any cross-sectional shape, positioned within any location within the apparatus 10, and sized according to the use of the apparatus. For example, as is shown in FIG. 1, the cable channel 30 may be formed with a fully enclosed cross section where there are no holes, slots, or breaks in the cable channel 30.

The elongated, temperature-controlling device 40 may be removably positioned within the cable channel 30. The elongated, temperature-controlling device 40 can be inserted, removed, or otherwise manipulated within the cable channel 30. The elongated, temperature-controlling device 40 may include any type of temperature-controlling device that is capable of fitting within the cable channel 30. For example, the elongated, temperature-controlling device 40 may include an electric heat trace that creates enough heat to prevent the fluid within the fluid-transporting tubes 20 from freezing in frigid conditions. The elongated, temperature-controlling device 40 may also include any other type of heating element, or any type of cooling element.

The cable channel 30 may be positioned between at least two of the plurality of fluid-transporting tubes 20, such that it can provide optimal heat or cooling to the fluid-transporting tubes 20. In some situations, the cable channel 30 may be in contact the plurality of fluid-transporting tubes 20. Any number of cable channel 30 and elongated, temperature-controlling device 40 may be used with the apparatus 10. The number of cable channel 30 and elongated, temperature-controlling device 40 may depend on the use and application of the apparatus 10.

The bundling jacket 50 may be positioned exterior of the fluid-transporting tubes 20, the cable channel 30, and the elongated, temperature-controlling device 40, thereby acting to protect and shield these components from the surrounding environment. The bundling jacket 50 may include a variety of different materials, including but not limited to an aluminum shield 52, a thermal insulation 54 positioned abutting the aluminum shield 52, and a jacket 56 positioned abutting the aluminum shield 54, as is shown in FIG. 1. The use of the aluminum shield 52, the thermal insulation 54, and the jacket 56 may be useful in industries utilizing the apparatus 10 in deep water settings, such as with off-shore drilling systems.

The elongated, temperature-controlling device 40 may be located within the cable channel 30 at any point within the manufacturing, installation, or use of the apparatus 10. For example, the cable channel 30 may be formed within the apparatus 10, and the bundling jacket 50 may be positioned about the fluid-transporting tubes 20 and the cable channel 30. Then, the elongated, temperature-controlling device 40 may be fed into the cable channel 30 from one end of the apparatus 10 to the other. This flexibility in inserting and removing the elongated, temperature-controlling device 40 at a user's convenience may allow for inserting the elongated, temperature-controlling device 40 after installation of the apparatus 10, or removal of the elongated, temperature-controlling device 40 from an apparatus 10 that has been in use for a length of time.

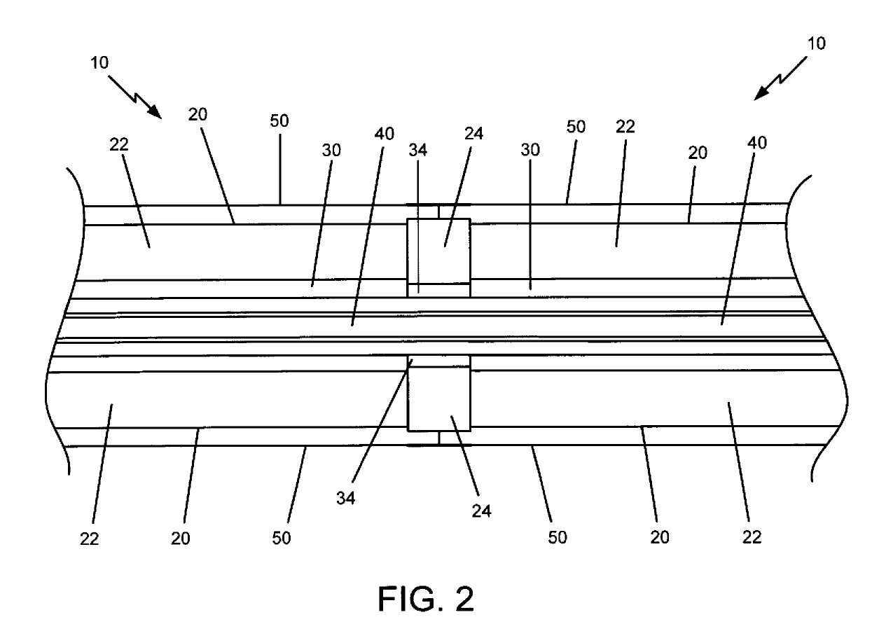

FIG. 2 is side cross-sectional illustration of the conduit apparatus 10, in accordance with the first exemplary embodiment of the present disclosure. Specifically, FIG. 2 depicts two apparatuses 10 aligned together as a conduit system. As can be seen, the plurality of fluid-transporting tubes 20 within each of the apparatuses 10 may be aligned and connected together to provide for a continuous fluid path within the interior portion 22 from apparatus 10 to apparatus 10. Similarly, the cable channel 30 of the apparatuses 10 is aligned and connected together to align the interior portion 32 of the cable channels 30. A connection device 24 may be used to interface and connect together the fluid-transporting tubes 20 and a connection device 34 may be used to connect together the cable channels 30. The connection devices 24, 34 may be independent from one another or formed together as an integral unity. The bundling jacket 50 is positioned surrounding the plurality of fluid-transporting tubes 20 and the cable channel 30, and connected together between the apparatuses 10. While the bundling jacket 50 of FIG. 2 is depicted without the various layers of material, such as the aluminum shield, the thermal insulation, or the jacket 56, it is noted that these materials may be used to form the bundling jacket 50.

In use, a plurality of apparatuses 10 within the conduit system may be aligned and connected together. The connection devices 24, 34 may be used to connect together the fluid-transporting tubes 20 and the cable channel 30, respectively, and the bundling jackets 50 may be linked together, or otherwise secured to protect the junction between the apparatuses 10. The elongated, temperature-controlling device 40, on the other hand, may be a continuous run of cabling material, such as wire, a heated cable, a heat-generating cable, or other conductor, which does not have a junction between the apparatuses 10. In other words, a single length of elongated, temperature-controlling device 40 may be run through any number of apparatuses 10.

Once the apparatuses 10 are connected together, the elongated, temperature-controlling device 40 positioned within the cable channels 30 of the apparatuses 10 may be removed therefrom. Alternatively, if the apparatuses 10 are connected together without an elongated, temperature-controlling device 40 within the cable channels 30, the elongated, temperature-controlling device 40 may be inserted into an open end of the cable channel 30 and fed through the length of a plurality of apparatuses 10. The use of a junction-free elongated, temperature-controlling device 40 within the apparatus provides many benefits in terms of providing a quality conduit has very few electrical connections or junctions between conduit sections, or preferably none at all.

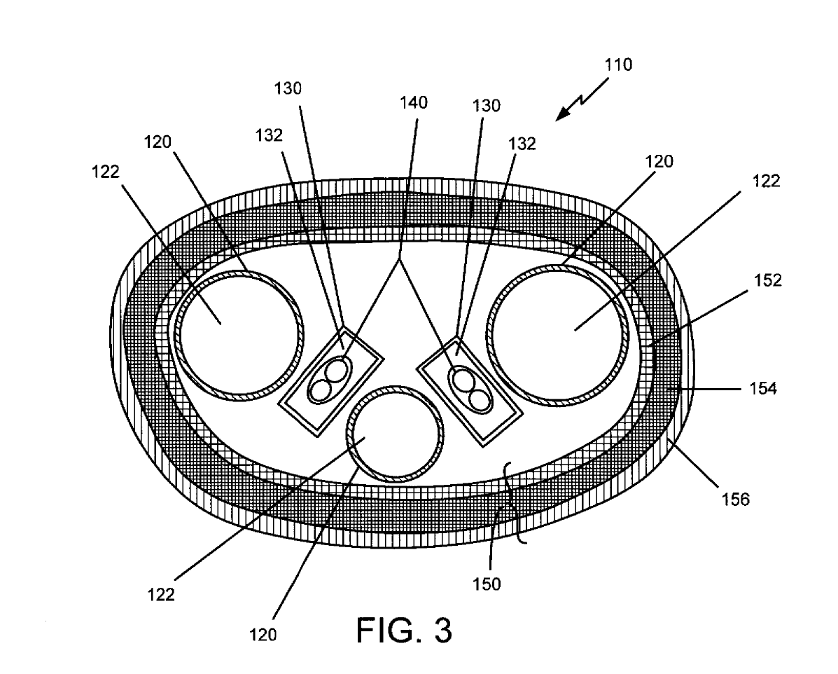

FIG. 3 is a front cross-sectional illustration of a conduit apparatus 110, in accordance with a second exemplary embodiment of the present disclosure. The conduit apparatus 110, which may be referred to herein as ‘apparatus 110’ may include any of the components, functions, or features of the apparatus 10 of the first exemplary embodiment. The apparatus 110 includes a plurality of fluid-transporting tubes 120. A cable channel 130 is positioned substantially parallel to the plurality of fluid-transporting tubes 120. An elongated, temperature-controlling device 140 is positionable within the cable channel 130. A bundling jacket 150 is surrounding the plurality of fluid-transporting tubes 120 and the cable channel 130. The bundling jacket 150 may be comprised of an aluminum shield 152, a thermal insulation 154 positioned abutting the aluminum shield 152, and a jacket 156 positioned abutting the aluminum shield 154.

In comparison to the first exemplary embodiment, the apparatus 110 of the second exemplary embodiment includes plurality of cable channels 130, each positioned substantially parallel to the plurality of fluid-transporting tubes 120 and interior of the bundling jacket 150. For larger size process apparatuses 110, there may be more than one cable channel 130 and elongated, temperature-controlling device 140 to provide a larger amount of heat to the apparatus 110. When multiple cable channel 130 are used, they may be positioned at various points within the apparatus 110, including between the fluid-transporting tubes 120, or within an insulation layer or the bundling jacket 150, among other positions. Any quantity of cable channels 130 or elongated, temperature-controlling devices 140 may be included with the apparatus.

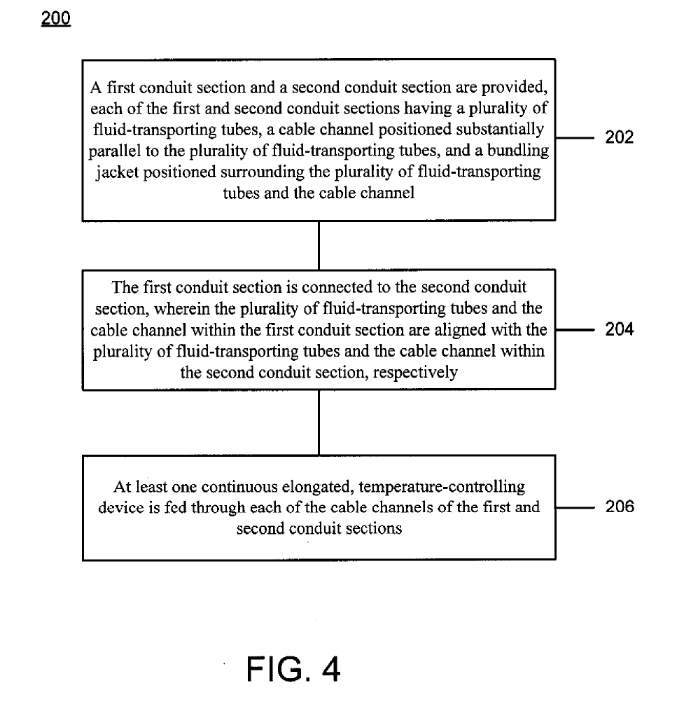

FIG. 4 is a flowchart 200 illustrating a method of using conduit, in accordance with a third exemplary embodiment of the present disclosure. It should be noted that any process descriptions or blocks in flow charts should be understood as representing modules, segments, portions of code, or steps that include one or more instructions for implementing specific logical functions in the process, and alternate implementations are included within the scope of the present disclosure in which functions may be executed out of order from that shown or discussed, including substantially concurrently or in reverse order, depending on the functionality involved, as would be understood by those reasonably skilled in the art of the present disclosure.

As is shown by block 202, a first conduit section and a second conduit section are provided, each of the first and second conduit sections having a plurality of fluid-transporting tubes, a cable channel positioned substantially parallel to the plurality of fluid-transporting tubes, and a bundling jacket positioned surrounding the plurality of fluid-transporting tubes and the cable channel. The first conduit section is connected to the second conduit section, wherein the plurality of fluid-transporting tubes and the cable channel within the first conduit section are aligned with the plurality of fluid-transporting tubes and the cable channel within the second conduit section, respectively (block 204). At least one continuous elongated, temperature-controlling device is fed through each of the cable channels of the first and second conduit sections (block 206).

Other steps may be included with the method, including steps for any of the structure or functionality disclosed relative to FIGS. 1-3, all of which are considered within the scope of the present disclosure. For example, the at least one continuous elongated, temperature-controlling device may be fed through each of the cable channels of the first and second conduits sections after the first and second conduit sections are connected together. When, for example, the elongated, temperature-controlling device is damaged, it may be removed from the cable channels of the first and second conduit sections and a second continuous elongated, temperature-controlling device may be fed through the cable channels of the first and second conduit sections. Removal and insertion of the elongated, temperature-controlling device may occur when the apparatus is in an installation positioned, such as when it is positioned in a down-hole within a ground surface, and/or between a surface of a body of water and substantially a floor of the body of water.

It should be emphasized that the above-described embodiments of the present disclosure, particularly, any “preferred” embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A conduit apparatus comprising:
a plurality of fluid-transporting tubes;
a cable channel positioned substantially parallel to the plurality of fluid-transporting tubes;
an elongated, temperature-controlling device positionable within the cable channel; and
a bundling jacket surrounding the plurality of fluid-transporting tubes and the cable channel.

2. The conduit apparatus of claim 1, wherein the bundling jacket further comprises:
an aluminum shield;
a thermal insulation positioned abutting the aluminum shield; and
a jacket positioned abutting the aluminum shield.

3. The conduit apparatus of claim 1, wherein the elongated, temperature-controlling device further comprises an electric heat trace cable.

4. The conduit apparatus of claim 1, wherein the elongated, temperature-controlling device further comprises a cooling element.

5. The conduit apparatus of claim 1, wherein the cable channel has a fully enclosed cross-section.

6. The conduit apparatus of claim 1, wherein the cable channel is positioned between at least two of the plurality of fluid-transporting tubes.

7. The conduit apparatus of claim 1, wherein the cable channel is in contact the plurality of fluid-transporting tubes.

8. The conduit apparatus of claim 1, wherein the elongated, temperature-controlling device is not affixed to an interior surface of the cable channel.

9. The conduit apparatus of claim 1, wherein the cable channel further comprises a plurality of cable channels, each positioned substantially parallel to the plurality of fluid-transporting tubes and interior of the bundling jacket.

10. The conduit apparatus of claim 1, further comprising a connection device affixed at a terminating end of the plurality of fluid-transporting tubes and the cable channel.

11. A conduit system comprising:
a first conduit section having a first plurality of fluid-transporting tubes and a first cable channel positioned substantially parallel to the first plurality of fluid-transporting tubes;
a second conduit section having a second plurality of fluid-transporting tubes and a second cable channel positioned substantially parallel to the second plurality of fluid-transporting tubes;
a bundling jacket positioned surrounding the first and second plurality of fluid-transporting tubes and the first and second cable channel;
a connection device fluidly interfacing the first plurality of fluid-transporting tubes and the second plurality of fluid-transporting tubes and interfacing the first cable channel and the second cable channel; and
an elongated, temperature-controlling device positioned within the first and second cable channels.

12. The conduit system of claim 11, wherein the bundling jacket is continuous from the first conduit section to the second conduit section.

13. The conduit system of claim 11, wherein the bundling jacket further comprises:
an aluminum shield;
a thermal insulation positioned abutting the aluminum shield; and
a jacket positioned abutting the aluminum shield.

14. The conduit system of claim 11, wherein the elongated, temperature-controlling device is continuous from the first cable channel to the second cable channel.

15. A method of using conduit comprising the steps of:
providing a first conduit section and a second conduit section, each of the first and second conduit sections having a plurality of fluid-transporting tubes, a cable channel positioned substantially parallel to the plurality of fluid-transporting tubes, and a bundling jacket positioned surrounding the plurality of fluid-transporting tubes and the cable channel;
connecting the first conduit section to the second conduit section, wherein the plurality of fluid-transporting tubes and the cable channel within the first conduit section are aligned with the plurality of fluid-transporting tubes and the cable channel within the second conduit section, respectively; and
feeding at least one continuous elongated, temperature-controlling device through each of the cable channels of the first and second conduit sections.

16. The method of claim 15, wherein the at least one continuous elongated, temperature-controlling device is fed through each of the cable channels of the first and second conduits sections after the first and second conduit sections are connected together.

17. The method of claim 16, further comprising the steps of:
removing the elongated, temperature-controlling device from the cable channels of the first and second conduit sections; and
feeding a second elongated, temperature-controlling device through the cable channels of the first and second conduit sections.

18. The method of claim 17, wherein the cable channels of the first and second conduit sections are positioned in an installation position, wherein the installation positioned further comprises at least one of:
a down-hole within a ground surface; and
between a surface of a body of water and substantially a floor of the body of water.

19. The method of claim 15, wherein the continuous elongated, temperature-controlling device further comprises an electric heat trace, wherein the plurality of fluid-transporting tubes are heated by the electric heat trace.

20. The method of claim 15, wherein the a bundling jacket further comprises:
an aluminum shield;
a thermal insulation positioned abutting the aluminum shield; and
a jacket positioned abutting the aluminum shield.
